(19) United States
(12) Patent Application Publication
(10) Pub. No.: US 2013/0147294 A1
(43) Pub. Date: Jun. 13, 2013

(54) SPINDLE MOTOR

(71) Applicant: SAMSUNG ELECTRO-MECHANICS CO., LTD., Gyunggi-do (KR)

(72) Inventors: Jong Ryeol Oh, Gyunggi-do (KR); Ho Kyung Jang, Gyunggi-do (KR)

(73) Assignee: SAMSUNG ELECTRO-MECHANICS CO., LTD., Gyunggi-do (KR)

(21) Appl. No.: 13/664,183

(22) Filed: Oct. 30, 2012

(30) Foreign Application Priority Data
Dec. 8, 2011 (KR) 10-2011-0130978

(51) Int. Cl. H02K 7/08

(52) U.S. Cl. 310/90

(57) ABSTRACT

The present invention has been made in an effort to provide a spindle motor using a fluid dynamic pressure bearing, in which sealing of a sealing part including an operating fluid interface may be more effectively performed at the time of operation or non-operation of the spindle motor.

According to the preferred embodiments of the present invention, the first protrusion is formed to correspond to the dynamic pressure groove, thereby making it possible to prevent the leakage of the operating fluid at external oscillation having various bands at the time of operation of the spindle motor. In addition, it is possible to minimize the leakage of the operating fluid through the second protrusion even though a balance between capillary force and atmospheric pressure is broken in the sealing part at the time of non-operation of the spindle motor.

### CROSS REFERENCE TO RELATED APPLICATION

This application claims the benefit of Korean Patent Application No. 10-2011-0130978, filed on Dec. 8, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, a spindle motor, which belongs to a brushless-DC motor (BLDC), has been widely used as a laser beam scanner motor for a laser printer, a motor for a floppy disk drive (FDD), a motor for an optical disk drive such as a compact disk (CD) or a digital versatile disk (DVD), or the like, in addition to a motor for a hard disk drive.

Recently, in a device such as a hard disk drive requiring high capacity and high speed driving force, a spindle motor including a fluid dynamic pressure bearing having lower driving friction as compared to an existing ball bearing has generally been used in order to minimize generation of noise and non repeatable run out (NRRO), which is vibration generated at the time of use of a ball bearing. In the fluid dynamic pressure bearing, a thin oil film is basically formed between a rotor and a stator, such that the rotor and the stator are supported by pressure generated at the time of rotation. Therefore, the rotor and stator are not in contact with each other, such that frictional load is reduced. In the spindle motor using the fluid dynamic pressure bearing, lubricating oil (hereinafter, referred to as ‘operating fluid) maintains a shaft of the motor rotating a disk only with dynamic pressure (pressure returning oil pressure to the center by centrifugal force of the shaft). Therefore, the spindle motor using the fluid dynamic pressure bearing is distinguished from a ball bearing spindle motor in that the shaft is supported by a shaft ball made of iron.

When the fluid dynamic pressure bearing is used in the spindle motor, the rotor is supported by the fluid, such that a noise amount generated in the motor is small, power consumption is low, and impact resistance is excellent.

However, in the case of the spindle motor using the fluid dynamic pressure bearing according to the prior art, various problems such as destruction of an operating fluid interface and leakage of the operating fluid to the outside, and the like, have been generated in an operating fluid sealing part of the fluid dynamic pressure bearing due to external impact, or the like. The leakage of the operating fluid deteriorates operating performance of the motor, thereby causing a serious problem such as deterioration in reliability of the motor operation.

### SUMMARY OF THE INVENTION

The present invention has been made in an effort to provide a spindle motor using a fluid dynamic pressure bearing, in which sealing of a sealing part including an operating fluid interface may be more effectively performed at the time of operation or non-operation of the spindle motor.

According to a preferred embodiment of the present invention, there is provided a spindle motor including: a shaft becoming a rotation center axis of the motor; a sleeve receiving the shaft therein and supporting the shaft; and a hub coupled to an upper portion of the shaft in an axial direction and provided with a sealing member protruded downwardly in the axial direction so as to face an outer peripheral surface of the sleeve while being spaced apart therefrom, wherein an operating fluid sealing part is formed in a space in which the outer peripheral surface of the sleeve and the sealing member face each other while being spaced apart from each other and a first protrusion protruded from the sealing member toward the space in which the sealing part is formed is formed on an inner side surface of the sealing member.

The first protrusion may be formed to be adjacent to an outer side of an operating fluid interface formed in the sealing part at the time of operation of the motor.

The first protrusion may be disposed at a central point of an axial length of the space in which the sleeve and the sealing member are formed to face each other.

The first protrusion may be formed at a position corresponding to that of a dynamic pressure groove formed in an outer peripheral surface of the sleeve facing the sealing member.

The dynamic pressure groove may have a herringbone shape.

The sealing member may be protruded downwardly from the hub in the axial direction and be formed integrally with the hub.

The spindle motor may further include a base coupled to an outer side surface of the sleeve so as to support the sleeve and having a core mounted on an inner side surface thereof, the core having a coil wound therearound, wherein the hub has an outer edge bent downwardly in the axial direction so that a rotor magnet is formed at a position facing the core.

According to another preferred embodiment of the present invention, there is provided a spindle motor including: a shaft becoming a rotation center axis of the motor; a sleeve receiving the shaft therein and supporting the shaft; and a hub coupled to an upper portion of the shaft in an axial direction and provided with a sealing member protruded downwardly in the axial direction so as to face an outer peripheral surface of the sleeve while being spaced apart therefrom, wherein an operating fluid sealing part is formed in a space in which the outer peripheral surface of the sleeve and the sealing member face each other while being spaced apart from each other and a second protrusion is formed to be protruded from the outer peripheral surface of the sleeve toward the space in which the sealing part is formed.

The second protrusion may be formed to be adjacent to an outer side of an operating fluid interface formed in the sealing part at the time of non-operation of the motor.

A first protrusion protruded from the sealing member toward the space in which the sealing part may be formed is formed on an inner side surface of the sealing member.

The first protrusion may be formed to be adjacent to an outer side of an operating fluid interface formed in the sealing part at the time of operation of the motor.

The first protrusion may be disposed at a central point of an axial length of the space in which the sleeve and the sealing member are formed to face each other.

The first protrusion may be formed at a position corresponding to that of a dynamic pressure groove formed in an outer peripheral surface of the sleeve facing the sealing member.

The dynamic pressure groove may have a herringbone shape.

The sealing member may be protruded downwardly from the hub in the axial direction and be formed integrally with the hub.

The spindle motor may further include a base coupled to an outer side surface of the sleeve so as to support the sleeve and having a core mounted on an inner side surface thereof, the core having a coil wound therearound, wherein the hub has an outer edge bent downwardly in the axial direction so that a rotor magnet is formed at a position facing the core.

### BRIEF DESCRIPTION OF THE DRAWINGS

FIG. 1 is a partially enlarged cross-sectional view of a spindle motor according to a preferred embodiment of the present invention;

FIG. 2 is an enlarged view of a sealing part at the time of non-operation of the spindle motor according to the preferred embodiment of the present invention;

FIG. 3 is an enlarged view of the sealing part at the time of operation of the spindle motor according to the preferred embodiment of the present invention; and

FIG. 4 is a cross-sectional view of the spindle motor according to the preferred embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In addition, the terms “first”, “second”, “one surface”, “the other surface” and so on are used to distinguish one element from another element, and the elements are not defined by the above terms. In the specification, an “axial direction” refers to a length direction of a shaft 11, which is a rotation center axis of a spindle motor. In describing the present invention, a detailed description of related known functions or configurations will be omitted so as not to obscure the gist of the present invention.

Hereinafter, preferred embodiments of the present invention will be described in detail with reference to the accompanying drawings.

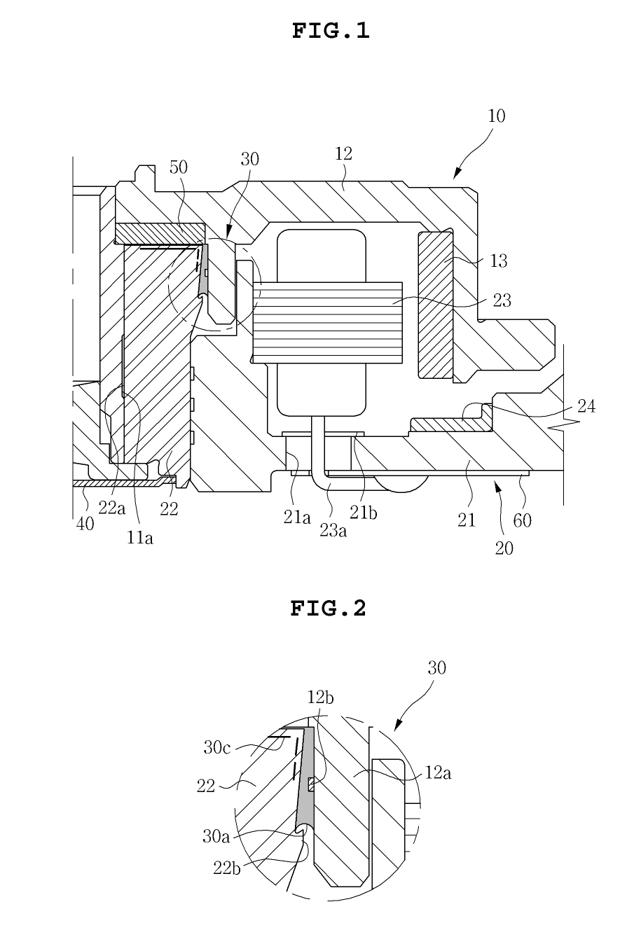

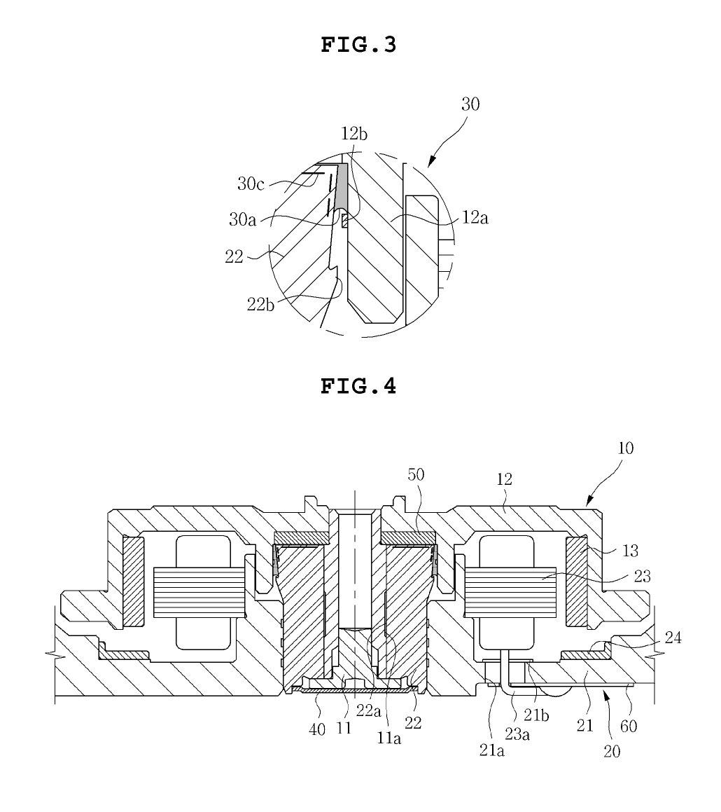

FIG. 1 is a partially enlarged cross-sectional view of a spindle motor according to a preferred embodiment of the present invention; FIG. 2 is an enlarged view of a sealing part at the time of non-operation of the spindle motor according to the preferred embodiment of the present invention; FIG. 3 is an enlarged view of the sealing part at the time of operation of the spindle motor according to the preferred embodiment of the present invention; and FIG. 4 is a cross-sectional view of the spindle motor according to the preferred embodiment of the present invention.

The spindle motor according to the preferred embodiment of the present invention is configured to include a shaft 11 becoming a rotation center axis of the motor; a sleeve 22 receiving the shaft 11 therein and supporting the shaft 11; and a hub 12 coupled to an upper portion of the shaft 11 in the axial direction and provided with a sealing member 12a protruded downwardly in the axial direction so as to face an outer peripheral surface of the sleeve 22 while being spaced apart therefrom, wherein an operating fluid sealing part 30 is formed in a space in which the outer peripheral surface of the sleeve 22 and the sealing member 12a face each other while being spaced apart from each other and a first protrusion 12b protruded from the sealing member 12a toward the space in which the sealing part 30 is formed is formed on an inner side surface of the sealing member 12a.

The shaft 11 becomes the center axis around which the spindle motor rotates and has generally a cylindrical shape. FIG. 1 shows an example in which a thrust dynamic pressure bearing part is formed between one end surface of the sleeve 22 receiving the shaft 11 therein and a lower end surface of the hub 12 facing one end surface of the sleeve 22. In order to form the thrust dynamic pressure bearing part, a separate thrust plate 50 may be formed on an upper end surface of the sleeve 22 in the axial direction. In addition, the thrust dynamic pressure bearing part may be formed between the upper end surface of the sleeve 22 in the axial direction and one surface of the hub 12 facing the upper end surface of the sleeve 22 in the axial direction. In this case, a dynamic pressure generation groove may be formed in any one of the upper end surface of the sleeve 22 and one surface of the hub 12 facing each other. Although not shown, the thrust plate 50 may be coupled integrally with the shaft 11 at the upper portion of the shaft 11 in the axial direction. In this case, they may be coupled to each other by press-fitting or bonding.

The sleeve 22 may receive the shaft 11 therein and have a hollow cylindrical shape so as to rotatably support the shaft 11, and a radial dynamic pressure bearing part by oil, which is operating fluid, may be formed in an outer peripheral surface 11a of the shaft 11 and an inner peripheral surface 22a of the sleeve 22 coupled to each other. In addition, a dynamic pressure generation groove (not shown) for generating dynamic pressure of the radial dynamic pressure bearing part may be formed in any one of the outer peripheral surface 11a of the shaft 11 and the inner peripheral surface 22a of the sleeve 22 in which the radial dynamic pressure bearing part is formed.

According to the preferred embodiment of the present invention, the sealing part 30 forming an operating fluid interface 30a by the operating fluid (including lubricating oil such as oil, or the like) may be formed in a spaced space in which a sealing member 12a to be described below and the outer peripheral surface of the sleeve 22 face each other. In order to maintain and manage the operating fluid interface 30a formed in the sealing part 30, a second protrusion 22b for preventing leakage of the operating fluid, or the like, may be formed on the outer peripheral surface of the sleeve 22.

The second protrusion 22b may be formed to be protruded from the outer peripheral surface of the sleeve 22 toward the space in which the sealing part 30 is formed. Particularly, the second protrusion 22b is formed to be adjacent to an outer side of the operating fluid interface 30a formed at the time of non-operation of the motor, thereby making it possible to prevent leakage of the operating fluid due to external impact, or the like. Here, the second protrusion 22b may be implemented by a shape of the sleeve 22 itself so as to be protruded from the outer peripheral surface of the sleeve 22 or may be implemented by adhering and coupling a separate member to the sleeve 22. A shape of the second protrusion 22b is not limited. However, the second protrusion 22b may have a shape in which it is bent upwardly in the axial direction so as to protect the operating fluid interface 30a formed in the sealing part 30 (See FIGS. 2 and 3).

The hub 12, which is to mount and rotate an optical disk (not shown) or a magnet disk (not shown) thereon, has the shaft 11 coupled integrally with the center thereof and is coupled to the upper portion of the shaft 11 so as to correspond to the upper end surface of the sleeve 22 in the axial direction. An outer edge of the hub 12 is bent downwardly in the axial direction, such that a rotor magnet 13 corresponding to a core 23 of a base 21 to be described below in a radial direction may be formed. The core 23 generates a magnetic flux while forming a magnetic flux when current flows. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12.

According to the preferred embodiment of the present invention, the hub 12 is coupled to the upper portion of the shaft 11 in the axial direction and is provided with a sealing member 12a protruded downwardly in the axial direction. The sealing member 12a may be formed integrally with the hub 12 or may be formed by coupling a separate member to the hub 12. The operating fluid sealing part 30 is formed in the spaced space between the inner side surface of the sealing member 12a protruded downwardly in the axial direction and the outer peripheral surface of the sleeve 22 facing the inner side surface of the sealing member 12a. In order to perform sealing of the sealing part 30, the spaced space between the outer peripheral surface of the sleeve 22 and the inner side surface of the sealing member 12a has a tapered shape in which a width thereof becomes wide downwardly in the axial direction, thereby making it possible to accomplish a sealing effect using a capillary phenomenon. However, in spite of this sealing effect, the operating fluid interface 30a is destructed due to external impact, or the like, at the tome of high speed rotation of the motor or at the time of non-rotation of the motor, such the operating fluid may be leaked to the outside. According to the preferred embodiment of the present invention, in order to prevent destruction of the operating fluid interface 30a formed in the sealing part 30 due to vibration generated at the time of operation of the motor or external impact, leakage of the operating fluid due to the destruction of the operating fluid interface 30a, or the like, the first protrusion 12b is formed on the inner side surface of the sealing member 12a so as to be protruded toward the spaced space forming the sealing part 30.

Since the operating fluid interface 30a moves to an upper portion of the sealing part 30 in the axial direction due to dynamic pressure generated by the operating fluid at the time of operation of the motor, the first protrusion 12b may be disposed to be adjacent to an outer side of the moved operating fluid interface 30a. In addition, the first protrusion 12b is disposed at a central point of a length of the sealing part 30 in the axial direction, thereby making it possible to prevent destruction of the operating fluid interface 30a, leakage of the operating fluid, or the like, at the time of operation of the motor. The first protrusion 12b may have various shapes such a rectangular shape, and the like, and be bent in a direction in which the operating fluid interface 30a at an upper side in the axial direction is formed in order to protect the operating fluid interface 30a. In addition, the first protrusion 12b is formed to a position corresponding to a position at which a dynamic pressure generation groove 30c having a herringbone shape is formed in the outer peripheral surface of the sleeve 22 facing the sealing member 12a, thereby making it possible to further increase a sealing effect of the operating fluid. Here, the dynamic pressure generation groove 30c may be formed in order to pump the operating fluid inwardly at the time of operation of the motor. Here, the dynamic pressure generation groove 30c may have a herringbone shape but is not necessarily limited thereto. That is, the dynamic pressure generation groove 30c may also have any shape as long as it may pump the operating fluid inwardly at the time of rotation of the motor.

Although only any one of the first and second protrusions 12b and 22b described above may be selectively used, both of them may also be disposed in the sealing part 30 in order to protect the operating fluid interface 30a and prevent leakage of the operating fluid at the time of operation and non-operation of the motor. However, a design of a combination forming the first and second protrusions 12b and 22b may be variously changed by those skilled in the art. In addition, it is obvious to those skilled in the art that a design is changed so that the first protrusion 12b is formed on the outer peripheral surface of the sleeve 22 or the second protrusion 22b is formed at a position corresponding to that of the sealing member 12a.

The base 21 has one side surface coupled to the outer peripheral surface of the sleeve 22 so that the sleeve 22 including the shaft 11 is coupled to an inner side thereof. The base 21 has the core 23 coupled to the other side surface thereof, which is an opposite side to one side surface thereof, at a position corresponding to that of the magnet 13 formed on the hub 12, wherein the core 23 has a winding coil wound therearound. The base 21 may serve to support the entire structure of the spindle motor at a lower portion of the spindle motor and be manufactured by press processing or die-casting. In the case in which the base 21 is manufactured by the press processing, the base 21 may be made of various metal materials such as aluminum, steel, and the like, particularly, a material having rigidity. The base 21 and the sleeve 22 may be assembled to each other by applying an adhesive to an inner surface of the base 21 or an outer surface of the sleeve 22. A conductive adhesive (not shown) for conduction between the base 21 and the sleeve 22 may be connected to and formed on a lower end surface of a portion at which the base 21 and the sleeve 22 are bonded to each other. The conductive adhesive is formed to allow excessive charges generated at the time of operation of the motor to flow out through the base 21, thereby making it possible to improve reliability of the operation of the motor.

The core 23 is generally formed by stacking a plurality of thin metal plates and is fixedly disposed on the base 21 including a flexible printed circuit board 60. A plurality of through-holes 21a may be formed in a lower end surface of the base 21 so as to correspond to the coil 23a led from the winding coil 23a, and the coil 23a led through the through-holes 21a may be soldered to a solder part to thereby be electrically connected to the flexible printed circuit board 60. An insulating sheet 21b may be formed at an inlet portion of the through-hole 21a in order to insulate the through-hole 21a and the coil 23a passing through the through-hole 21a from each other.

A cover member 40 is coupled in order to cover an axial lower end surface of the sleeve 22 including the shaft 11. The cover member 40 includes a dynamic pressure generation groove formed in an inner side surface facing the lower end surface 11b of the shaft 11, thereby making it possible to form a thrust dynamic pressure bearing part. The cover member 40 may have a structure in which it is coupled to a distal end of the sleeve 22, such that the oil, which is the operating fluid, may be stored therein.

Components of the spindle motor according to the preferred embodiment of the present invention and an operation relationship therebetween will be briefly described below with reference to FIG. 4.

A rotor 10 includes the shaft 11 that becomes a rotation axis and is rotatably formed and the hub 12 having the rotor magnet 13 attached thereto, and a stator 20 includes the base 21, the sleeve 22, the core 23, and a pulling plate 24. Each of the core 23 and the rotor magnet 13 is attached to an outer side of the base 21 and an inner side of the hub 12 while facing each other. When current is applied to the core 23, a magnetic flux is generated while a magnetic field is formed. The rotor magnet 13 facing the core 23 includes repeatedly magnetized N and S poles to thereby form an electrode corresponding to a variable electrode generated in the core 23. The core 23 and the rotor magnet 13 have repulsive force generated therebetween due to electromagnetic force by interlinkage of magnetic fluxes to rotate the hub 12 and the shaft 11 coupled to the hub 12, such that the spindle motor according to the preferred embodiment of the present invention is driven. In addition, in order to prevent floating at the time of driving of the motor, the pulling plate 24 is formed on the base 21 so as to correspond to the rotor magnet 13 in the axial direction. The pulling plate 24 and the rotor magnet 13 have attractive force acting therebetween, thereby making it possible to stably rotate the motor.

As set forth above, according to the preferred embodiments of the present invention, it is possible to prevent scattering of oil due to external impact, or the like, at the time of non-operation of the spindle motor.

In addition, the operating fluid is more effectively managed in the spindle motor using the fluid dynamic pressure bearing, thereby making it possible to improve performance and reliability of the operation of the spindle motor.

Further, it is possible to prevent the leakage of the operating fluid caused by scattering of the operation fluid due to vibration that may be generated at the time of operation of the spindle motor or external impact.

Furthermore, the first protrusion is formed to correspond to the dynamic pressure groove, thereby making it possible to prevent the leakage of the operating fluid at external oscillation having various bands at the time of operation of the spindle motor.

Moreover, it is possible to minimize the leakage of the operating fluid through the second protrusion even though a balance between capillary force and atmospheric pressure is broken in the sealing part at the time of non-operation of the spindle motor.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a shaft becoming a rotation center axis of the motor;
a sleeve receiving the shaft therein and supporting the shaft; and
a hub coupled to an upper portion of the shaft in an axial direction and provided with a sealing member protruded downwardly in the axial direction so as to face an outer peripheral surface of the sleeve while being spaced apart therefrom,
wherein an operating fluid sealing part is formed in a space in which the outer peripheral surface of the sleeve and the sealing member face each other while being spaced apart from each other and a first protrusion protruded from the sealing member toward the space in which the sealing part is formed is formed on an inner side surface of the sealing member.

2. The spindle motor as set forth in claim 1, wherein the first protrusion is formed to be adjacent to an outer side of an operating fluid interface formed in the sealing part at the time of operation of the motor.

3. The spindle motor as set forth in claim 1, wherein the first protrusion is disposed at a central point of an axial length of the space in which the sleeve and the sealing member are formed to face each other.

4. The spindle motor as set forth in claim 1, wherein the first protrusion is formed at a position corresponding to that of a dynamic pressure groove formed in an outer peripheral surface of the sleeve facing the sealing member.

5. The spindle motor as set forth in claim 4, wherein the dynamic pressure groove has a herringbone shape.

6. The spindle motor as set forth in claim 1, wherein the sealing member is protruded downwardly from the hub in the axial direction and is formed integrally with the hub.

7. The spindle motor as set forth in claim 1, further comprising a base coupled to an outer side surface of the sleeve so as to support the sleeve and having a core mounted on an inner side surface thereof, the core having a coil wound therearound,
wherein the hub has an outer edge bent downwardly in the axial direction so that a rotor magnet is formed at a position facing the core.

8. A spindle motor comprising:
a shaft becoming a rotation center axis of the motor;
a sleeve receiving the shaft therein and supporting the shaft; and
a hub coupled to an upper portion of the shaft in an axial direction and provided with a sealing member protruded downwardly in the axial direction so as to face an outer peripheral surface of the sleeve while being spaced apart therefrom,
wherein an operating fluid sealing part is formed in a space in which the outer peripheral surface of the sleeve and the sealing member face each other while being spaced apart from each other and a second protrusion is formed to be protruded from the outer peripheral surface of the sleeve toward the space in which the sealing part is formed.

9. The spindle motor as set forth in claim 8, wherein the second protrusion is formed to be adjacent to an outer side of an operating fluid interface formed in the sealing part at the time of non-operation of the motor.

10. The spindle motor as set forth in claim 8, wherein a first protrusion protruded from the sealing member toward the space in which the sealing part is formed is formed on an inner side surface of the sealing member.

11. The spindle motor as set forth in claim 10, wherein the first protrusion is formed to be adjacent to an outer side of an operating fluid interface formed in the sealing part at the time of operation of the motor.

12. The spindle motor as set forth in claim 10, wherein the first protrusion is disposed at a central point of an axial length of the space in which the sleeve and the sealing member are formed to face each other.

13. The spindle motor as set forth in claim 10, wherein the first protrusion is formed at a position corresponding to that of a dynamic pressure groove formed in an outer peripheral surface of the sleeve facing the sealing member.

14. The spindle motor as set forth in claim 10, wherein the dynamic pressure groove has a herringbone shape.

15. The spindle motor as set forth in claim 10, wherein the sealing member is protruded downwardly from the hub in the axial direction and is formed integrally with the hub.

16. The spindle motor as set forth in claim 9, further comprising a base coupled to an outer side surface of the sleeve so as to support the sleeve and having a core mounted on an inner side surface thereof, the core having a coil wound therearound,
wherein the hub has an outer edge bent downwardly in the axial direction so that a rotor magnet is formed at a position facing the core.
